(19) United States
(12) Patent Application Publication
(10) Pub. No.: US 2025/0357651 A1
(43) Pub. Date: Nov. 20, 2025

(54) APPARATUS AND METHOD ACCELERATING ELECTRILYTE FILLING PROCESS

(71) Applicant: GM GLOBAL TECHNOLOGY OPERATIONS LLC, Detroit, MI (US)

(72) Inventors: Xingcheng Xiao, Troy, MI (US); Mei Cai, Bloomfield Hills, MI (US); John P. Healy, Rochester Hills, MI (US)

(73) Assignee: GM GLOBAL TECHNOLOGY OPERATIONS LLC, Detroit, MI (US)

(21) Appl. No.: 18/664,949

(22) Filed: May 15, 2024

(51) Int. Cl. H01M 50/618; H01M 50/491; H01M 50/627; H01M 50/673

(52) U.S. Cl. CPC H01M 50/618; H01M 50/491; H01M 50/627; H01M 50/673

(57) ABSTRACT

Disclosed is an apparatus for and method of wetting, with a liquid solvent, a plurality of pore surfaces formed a substrate of a lithium-ion battery, and thereafter, filling the lithium-ion battery with a liquid electrolyte.

### INTRODUCTION

The technical field generally relates to batteries, compartments thereof, and methods of making the same.

The process of making lithium ion batteries in large scale production involves filling the battery cells of each battery with an electrolyte solution. A substantial amount of time is required to allow the electrolyte solution to fill the narrow spaces between the battery components and to allow the electrolyte solution to fill pores in the interior surfaces of battery components for acceptable performance and to avoid lithium plating during operation of the battery.

It is desirable to make an apparatus and method of filling batteries with an electrolyte solution (liquid electrolyte) that reduces the time to fill each battery and ensure or increase the likelihood that pores in the interior surfaces of the battery components are filled. Furthermore, other desirable features and characteristics of the variations disclosed herein will become apparent from the subsequent detailed description and the appended claims, taken in conjunction with the accompanying drawings and the foregoing.

### SUMMARY

A number of variations may include a method including: flowing a solvent vapor over a plurality of interior surfaces of a battery cell, wherein at least one of the plurality of interior surfaces of the battery cell has a plurality of pores formed therein, each pore of the plurality of pores being defined by a pore surface; condensing the solvent vapor to a liquid solvent so that the liquid solvent is deposited at least the pore surface of each pore of the plurality of pores; and thereafter, filling the battery cell with a solution including a solvent and a salt.

A number of variations may include a method wherein the liquid solvent is deposited on the at least one of the plurality of interior surfaces.

A number of variations may include a method further including flowing a carrier gas along with the solvent vapor over the plurality of interior surfaces of the battery cell.

A number of variations may include a method further including drawing a vacuum on the battery cell to remove gas from the battery cell prior to flowing the solvent vapor over the plurality of interior surfaces of the battery cell.

A number of variations may include a method wherein the solvent vapor has a vapor pressure and a vapor temperature, and wherein condensing the solvent vapor to the liquid solvent including adjusting at least one of the vapor pressure or the vapor temperature.

A number of variations may include a method wherein the solvent vapor has a vapor pressure and further including adjusting the vapor pressure to promote capillary condensation.

A number of variations may include a method further including heating the solvent vapor flowing over the plurality of interior surfaces of the battery cell.

A number of variations may include a method further including heating a solvent to produce the solvent vapor.

A number of variations may include a method wherein heating the solvent to produce the solvent vapor is performed in a bubbler.

A number of variations may include a method further including flowing a carrier gas into the bubbler and flowing the carrier gas and the solvent vapor over the plurality of interior surfaces of the battery cell.

A number of variations may include a method wherein the plurality of interior surfaces of the battery cell including at least one interior surface of a housing enclosing the battery cell, a first electrode, a second electrode, and a separator between the first electrode and the second electrode.

A number of variations may include a method further comprising a housing enclosing the battery cell; wherein the plurality of interior surfaces of the battery cell comprising at least one interior surface of a housing enclosing the battery cell, a first electrode, a second electrode, and a separator between the first electrode and the second electrode; heating a solvent to produce the solvent vapor; and flowing a carrier gas into a bubbler and flowing the carrier gas and the solvent vapor over the plurality of interior surfaces of the battery cell.

A number of variations may include a method including: wetting, with a liquid solvent, a plurality of pores surfaces formed in a substrate of a lithium-ion battery; and thereafter, filling the lithium-ion battery with a liquid electrolyte.

A number of variations may include a method wherein the wetting includes flowing a solvent vapor over the plurality of pores surfaces formed in the substrate, and thereafter condensing the solvent vapor to the liquid solvent.

A number of variations may include a method wherein the substrate includes at least one of an anode, an active material on the anode, a first face of a separator, a second face of the separator, a cathode, an active material on the cathode, or a surface of a battery housing.

A number of variations may include a product including: a bubbler including a container and a heat source, a solvent vapor conduit connected to the container and to an electrolyte hopper, the electrolyte hopper having an open end for filling a lithium-ion battery.

A number of variations may include a product further including a carrier gas conduit connected to the container, the carrier gas conduit having a discharge end positioned to flow carrier gas into the container.

A number of variations may include a product further including a vacuum conduit connected to the electrolyte hopper.

A number of variations may include a product further including a filling port connected to the electrolyte hopper for filling liquid solvent into the electrolyte hopper.

A number of variations may include a product further including a vacuum pump connected to the vacuum conduit.

### BRIEF DESCRIPTION OF THE DRAWINGS

The variations will hereinafter be described in conjunction with the following drawing figures, wherein like numerals denote like elements, and wherein:

FIG. 1 is a perspective, schematic illustration of select components of a lithium-ion battery and method according to a number of variations;

FIG. 2 is a perspective, schematic illustration of select components of a lithium-ion battery and method according to a number of variations;

FIG. 3 is a perspective view of select components of a lithium-ion battery, with portions removed, according to a number of variations;

FIG. 4 a method of wetting a surface of a battery cell according to a number of variations;

FIGS. 5A-5F illustrate an apparatus and acts in a method according to a number of variations;

FIG. 6 illustrates a method according to a number of variations;

FIG. 7 illustrates a method according to a number of variations;

FIG. 8 is a perspective, schematic illustration of a prismatic battery according to a number of variations;

FIG. 9 illustrates prismatic battery and an apparatus for wetting interior poor surfaces of the prismatic battery thereafter filling the prismatic battery with an electrolyte including a solvent and a salt according to a number of variations; and

FIG. 10 illustrates prismatic battery and an apparatus for wetting interior poor surfaces of the prismatic battery thereafter filling the prismatic battery with an electrolyte including a solvent and a salt according to a number of variations.

### DETAILED DESCRIPTION

The following detailed description is merely illustrative in nature and is not intended to limit the application and uses. Furthermore, there is no intention to be bound by any expressed or implied theory presented in the preceding introduction, summary, brief description of the drawings, or the following detailed description.

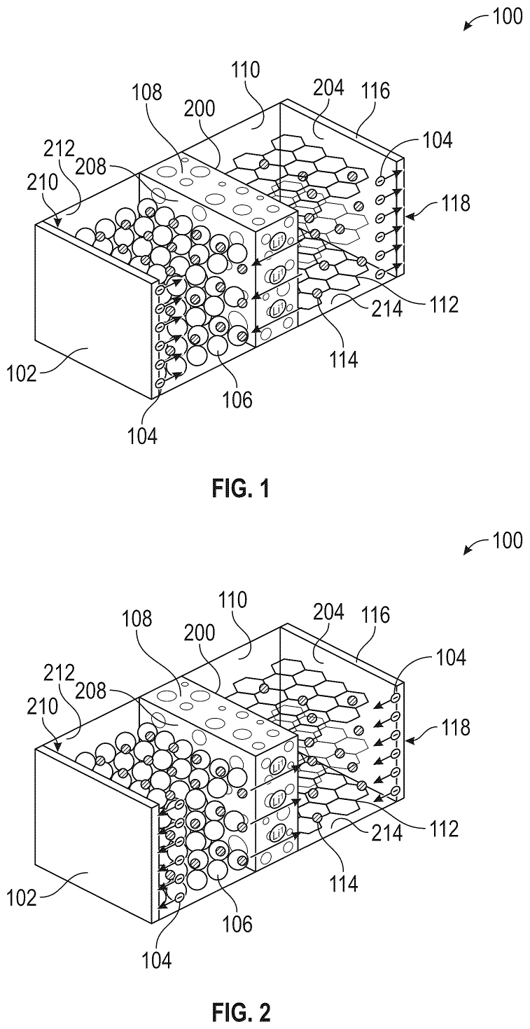

FIGS. 1 and 2 illustrate a product which may be a lithium-ion battery and methods of discharging and charging according to a number of variations. The product 100 which may be a battery cell which may include a first electrode 102, for example a cathode, and a first active material 106 on or adjacent to the first electrode 102. For a cathode electrode, the first active material 106 may be deposited on the first electrode 102 with a composition including metal oxides as the active material along with one or more conductive additives and one or more binders. The first active material 106 may include, but not limited to, at least one of lithium cobalt oxide (LiCoO2), lithium manganese oxide (LiMn2O4), lithium iron phosphate (LiFePO4 or LFP), or lithium nickel manganese cobalt oxide (LiNiMnCoO2 or NMC). A second electrode 116, for example an anode, may be provided and a second active material 112 may be deposited on the second electrode 116. The second active material 112 may include, but not limited to, at least one of carbon-based materials such as graphite, silicon, or a combination of both, or lithium metal carbon materials. A separator 108 may be provided between the first electrode 102 and the second electrode 116 and may be constructed and arranged to allow the movement of lithium ions therethrough. The product 100 may also include an electrolyte 110. The electrolyte 110 may include, but not limited to, at least one of LiPF6, LiBF4, or LiClO4, in an organic solvent.

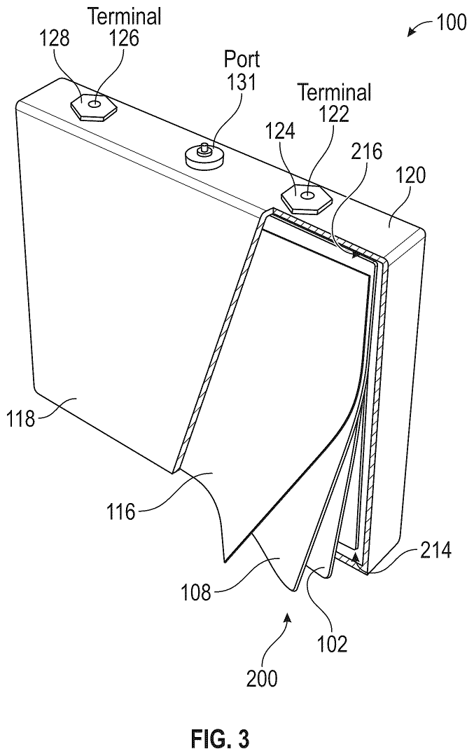

The lithium battery 100 may include a plurality of inner surfaces which may include a plurality of pores of a variety of sizes including, but not limited to, at least one of a milli-pore, micro-pore, or nano-pore. The plurality of inner surface may include at least a surface of the anode 116 or the active material 204 thereon, a first face 206 and a second face 208 of the separator 108, the cathode 102 or the active material 210 on the cathode, a side wall 212 or bottom wall 214 of the housing 118. The housing 118 may also include a cap plate 120 (shown in FIG. 3) which may have an inner surface.

Referring again to FIG. 1, while the product 100 (battery) is discharging and providing an electric current, for example to power an electric motor in a vehicle, the second electrode 116 (anode) or the second active material 112 releases lithium ions 114 to the first electrode 102 (cathode) or first active material 106, generating a flow of electrons 104 from second electrode 116 (anode) to the first electrode 102 (cathode). Referring again to FIG. 2, when plugging in the product 100 (battery) to a source of electric current, the opposite happens, so that lithium ions 114 are released by the first electrode 102 (cathode) or first active material 106 and are received by the second electrode 116 (anode) of second active material 112.

FIG. 3 illustrates a product 100 which may be a battery and may include a plurality of battery cells 200 which may include the first electrode 102 (cathode) and the second electrode 116 (anode) and the separator 108 therebetween. The plurality of battery cells 200 may be enclosed in a housing 118 which may be made from a material including a metal, such as but not limited to, aluminum or steel. A cap plate 120 may be provided as part of the housing 118 or as a separate piece. The first terminal 122 may extend through the cap plate 120 and may be electrically isolated from the cap plate 120 by a first electrical insulation material 124. The second terminal 126 may extend through the cap plate 120 and may be electrically isolated from the cap plate 120 by a second electrical insulation material 128. An electrolyte injection port 131 may be provided in the cap plate 120.

A number of variations are illustrated in FIG. 3, which may include an electrode stack 142 which may include a plurality of battery cells 200, wherein the first electrode 102 may include a first electrode tab 140, which may be a cathode tab, and wherein the second electrode 116 may include a second electrode tab 144, which may be an anode tab.

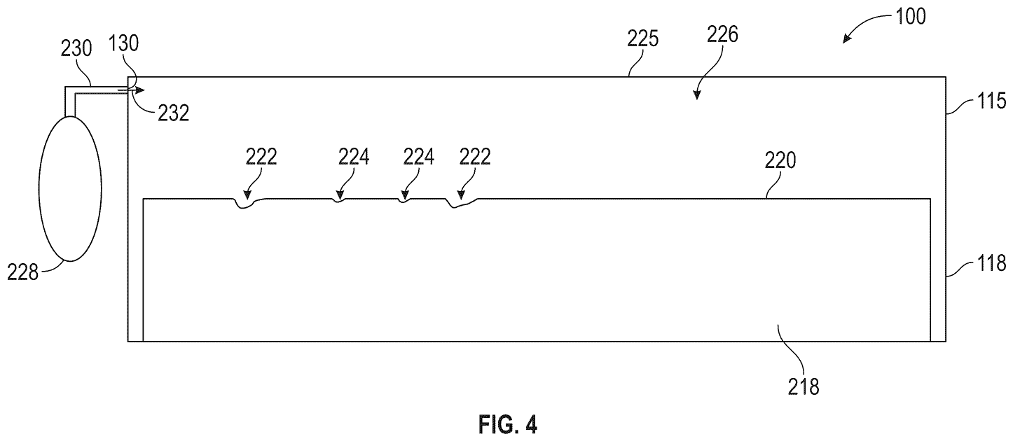

A number of variations are illustrated in FIG. 4 which may include a substrate 218 having an interior surface 220 including a plurality of pores 222, 224 which may include at least one of a milli-pore, micro-pore, or nano-pore. Each pore may be defined by a pore surface. A solvent vapor source 228 may be provided including a solvent vapor conduit 230 connected to a port 130 of the housing 118 to flow solvent vapor over the interior surface 220 of the substrate 218 and into the plurality of pores 222, 224. The solvent vapor may be condensed to a liquid solvent deposited over the pore surface defining each pore of the plurality of pores 222, 224. The liquid solvent in the pores 222, 224 may have a variety of thicknesses, for example but not limited to a thickness ranging from 1-20 molecules, 2-10 molecules, 2-6 molecules, 2-4 molecules or any range between 1 and 20 molecules. The housing 118 may include a portion 225 defining a head space chamber 226 to receive the solvent vapor to improve the flow of the solvent vapor into a plurality of battery cells 200 in the housing 118. In a number of variations, the solvent vapor may include at least one or more of the same solvent(s) used in an electrolyte solution including a solvent and a salt as described hereafter.

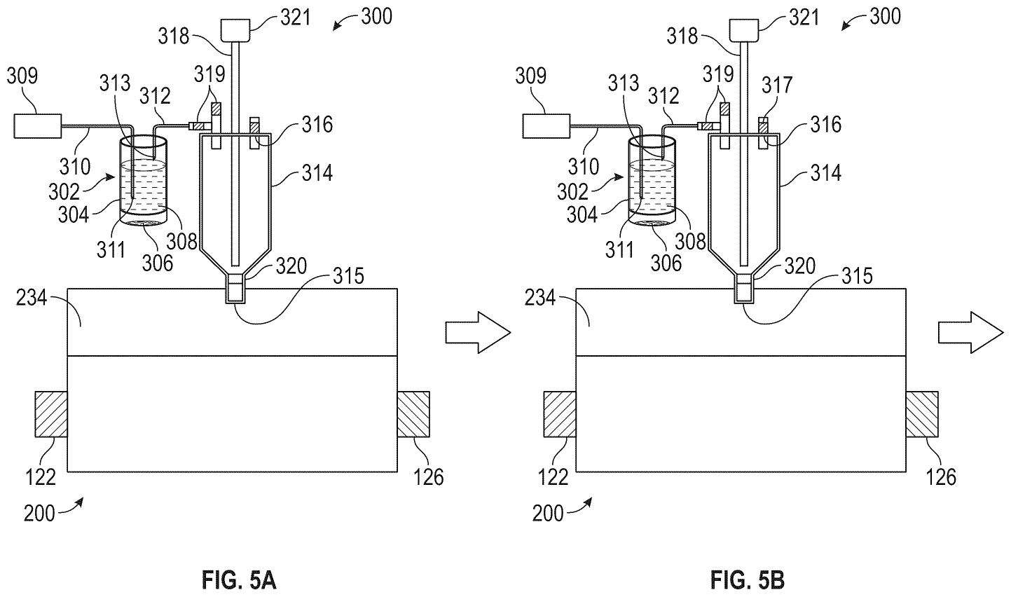

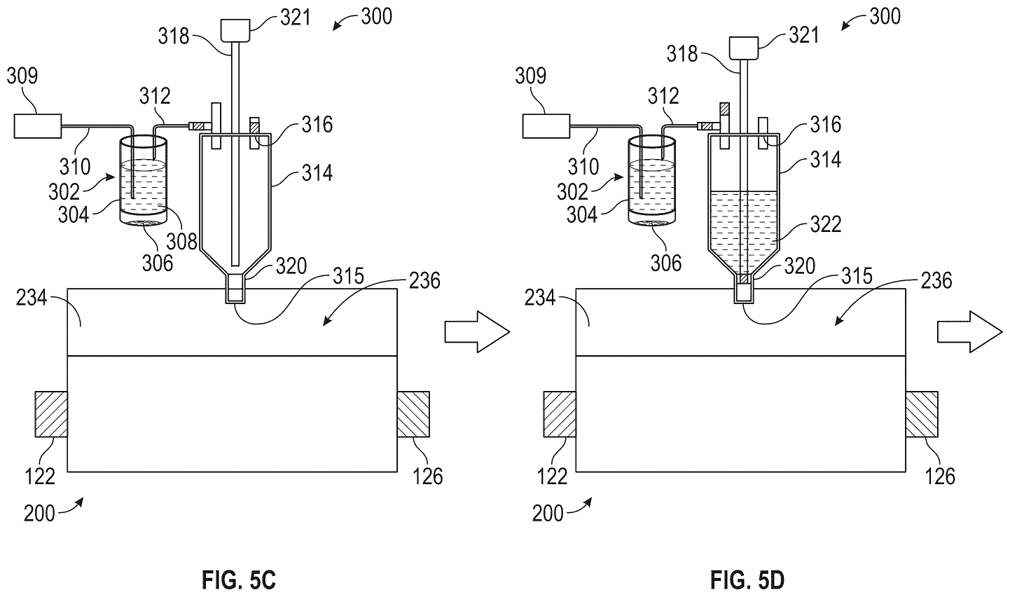

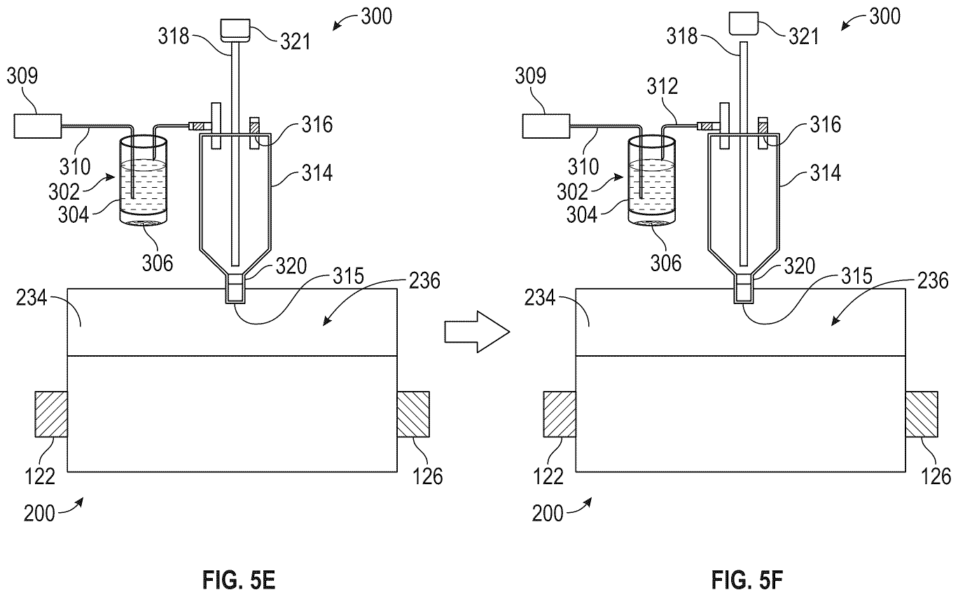

A number of variations are illustrated in FIGS. 5A-5F, which may include an apparatus 300 which may include a bubbler 302 which may include a container 304 and a heat source 306. The heat source 306 may be an electric coil, or a combustible fuel such as, but not limited to, natural gas or propane. The container 304 may be constructed and arranged to hold liquid solvent 308 therein. A carrier gas conduit 310 may be connected to a carrier gas source 309 and may have a discharge end 311 extending into the container 304 before so that the discharge and 312 is submerged in the liquid solvent 308. The carrier gas source 309 may be a tank of carrier gas. The carrier gas may be any of a variety of gases including, but not limited to, argon or nitrogen. A solvent vapor conduit 312 may be connected to the container 304 and may have an inlet 313 positioned above the liquid solvent 308 in the container 304. The solvent vapor conduit 312 may be connected to an electrolyte hopper 314 and may have an open end 315 for dispensing solvent vapor and/or carrier gas into the battery cells 200. At least one valve 319 may be provided to control the flow of solvent vapor and/or carrier gas into the electrolyte hopper 314. An electrolyte hopper valve 320 may be provided near the opened in 315 of the electrolyte hopper 314 to selectively charge materials into the battery cells 200. A filling port 316 may be provided in the electrolyte hopper 314 to fill liquid electrolyte into the electrolyte hopper 314. A filling port valve 317 may be provided in the filling port 316.

The apparatus 300 may be used to carry out a number of acts in a method illustrated in FIGS. 5A-5F. For example, in FIG. 5A a vacuum pump 321 may be used to draw a vacuum on the battery cells 200 to remove any air or gas from the battery cells 200. Thereafter, as illustrated in FIG. 5B, carrier gas and solvent vapor may be charged into the electrolyte hopper 314 and into the battery cells 200 to flow over the interior surfaces of the battery cells 200. At least one of pressure or temperature may be adjusted to cause the solvent vapor to condense on the interior surfaces of the battery cells 200 and into the plurality of pores 222, 224 (illustrated in FIG. 4). In a number of variations, pressure of the solvent vapor is adjusted to cause capillary condensation of the solvent vapor. Causing solvent vapor to condense wets the interior surfaces with liquid solvent which reduces the time it takes to fill the battery cells 200 with an electrolyte including a solvent and a salt as will be described hereafter. Thereafter, as illustrated in FIG. 5C, a vacuum is drawn on the battery cells 200. Thereafter, as illustrated in FIG. 5D, the electrolyte hopper 314 may be charged with a liquid electrolyte 322 including a solvent and electrolyte. Thereafter, as illustrated in FIG. 5E, the electrolyte hopper valve 320 may be opened to fill the liquid electrolyte 322 into the battery cells 200. Thereafter, as illustrated in FIG. 5F, a vacuum may be pulled on the battery cells 200 to remove any air or carrier gas.

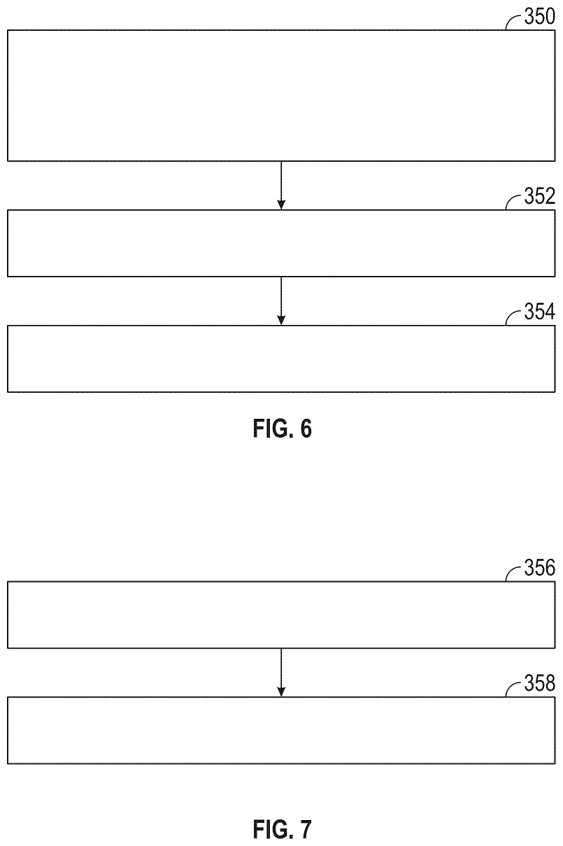

FIG. 6 illustrates a method which may include flowing a solvent vapor over a plurality of interior surfaces of a battery cell, wherein at least one of the plurality of interior surfaces of the battery cell has a plurality of pores formed therein, each pore of the plurality of pores being defined by a pore surface 350. condensing the solvent vapor to a liquid solvent so that the liquid solvent is deposited at least on the pore surface of each pore of the plurality of pores 352. And thereafter, filling the battery cell with a solution including a solvent and a salt 354.

FIG. 7 illustrates a method which may include wetting, with a liquid solvent, a plurality of pores surfaces formed in a substrate of a lithium-ion battery 356. And thereafter, filling the lithium-ion battery with a liquid electrolyte 358.

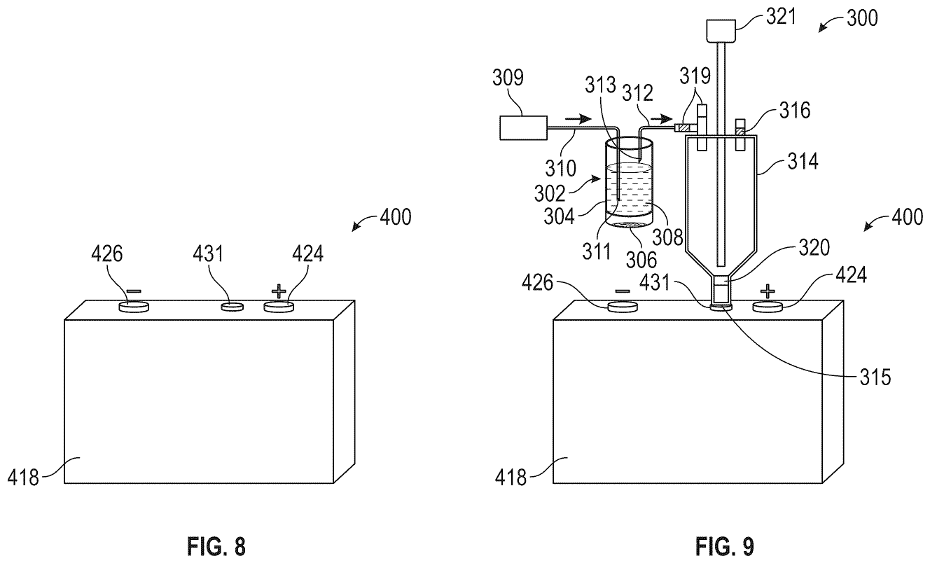

FIG. 8 is a perspective, schematic illustration of a prismatic battery 400 according to a number of variations. The prismatic battery 400 includes same interior components described with respect to FIGS. 1-2 which may include an interior surface 220, having a plurality of pores 222, 224 defined by a pore surface. The prismatic battery 400 may include a housing 418 which may be made from a metal and may be inflexible.

The apparatus 300 and the steps described herein for wetting pore surfaces with a solvent and thereafter filling a battery or battery cell with electrolyte including a solvent and the salt may be utilized for a variety of batteries and battery cells including, but not limited to, pouch battery cells, prismatic battery cells, and cylindrical battery cells. FIG. 9 illustrates an apparatus 300 as previously described with respect to FIGS. 5A-F and the steps illustrated by FIGS. 5A-F that may be carried out as described herein with respect to the prismatic battery 400.

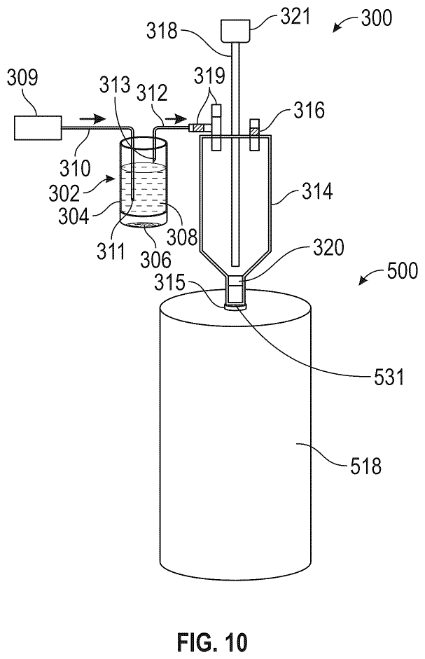

FIG. 10 illustrates a cylindrical battery 500 and an apparatus 300 as previously described with respect to FIGS. 5A-F and the steps illustrated by FIGS. 5A-F that may be carried out as described herein with respect to the cylindrical battery 500. The cylindrical battery 500 may include a housing 518 which may be made from a metal and may be inflexible.

Clause 1. A method comprising: flowing a solvent vapor over a plurality of interior surfaces of a battery cell, wherein at least one of the plurality of interior surfaces of the battery cell has a plurality of pores formed therein, each pore of the plurality of pores being defined by a pore surface; condensing the solvent vapor to a liquid solvent so that the liquid solvent is deposited at least on the pore surface of each pore of the plurality of pores; and thereafter, filling the battery cell with an electrolyte including a solvent and a salt.

Clause 2. The method as set forth in clause 1 wherein the liquid solvent is deposited on the at least one of the plurality of interior surfaces.

Clause 3. The method as set forth in clause 1 further comprising flowing a carrier gas along with the solvent vapor over the plurality of interior surfaces of the battery cell.

Clause 4. The method as set forth in clause 1 further comprising drawing a vacuum on the battery cell to remove gas from the battery cell prior to flowing the solvent vapor over the plurality of interior surfaces of the battery cell.

Clause 5. The method as set in clause 1 wherein the solvent vapor has a vapor pressure and a vapor temperature, and wherein condensing the solvent vapor to the liquid solvent comprising adjusting at least one of the vapor pressure or the vapor temperature.

Clause 6. The method as set forth in clause 1 wherein the solvent vapor has a vapor pressure and further comprising adjusting the vapor pressure to promote capillary condensation.

Clause 7. The method as set forth in clause 1 further comprising heating the solvent vapor flowing over the plurality of interior surfaces of the battery cell.

Clause 8. The method as set forth in clause 1 further comprising heating a solvent to produce the solvent vapor.

Clause 9. The method as set forth in clause 8 wherein heating the solvent to produce the solvent vapor is performed in a bubbler.

Clause 10. The method as set forth in clause 9 further comprising flowing a carrier gas into the bubbler and flowing the carrier gas and the solvent vapor over the plurality of interior surfaces of the battery cell.

Clause 11. The method as set forth in clause 1 wherein the plurality of interior surfaces of the battery cell comprising at least one interior surface of a housing enclosing the battery cell, a first electrode, a second electrode, and a separator between the first electrode and the second electrode.

Clause 12. The method as set forth in clause 1 further comprising a housing enclosing the battery cell; wherein the plurality of interior surfaces of the battery cell comprising at least one interior surface of a housing enclosing the battery cell, a first electrode, a second electrode, and a separator between the first electrode and the second electrode; heating a solvent to produce the solvent vapor; and flowing a carrier gas into a bubbler and flowing the carrier gas and the solvent vapor over the plurality of interior surfaces of the battery cell.

Clause 13. A method comprising: wetting, with a liquid solvent, a plurality of pores surfaces formed in a substrate of a lithium-ion battery; and thereafter, filling the lithium-ion battery with a liquid electrolyte.

Clause 14. The method as set forth in clause 13 wherein the wetting comprises flowing a solvent vapor over the plurality of pores surfaces formed in the substrate, and thereafter condensing the solvent vapor to the liquid solvent.

Clause 15. The method as set forth in clause 14 wherein the substrate comprises at least one of an anode, an active material on the anode, a first face of a separator, a second face of the separator, a cathode, an active material on the cathode, or a surface of a battery housing.

Clause 16. A product comprising: a bubbler including a container and a heat source, a solvent vapor conduit connected to the container and to an electrolyte hopper, the electrolyte hopper having an open end for filling a lithium-ion battery.

Clause 17. The product as set forth in clause 16 further comprising a carrier gas conduit connected to the container, the carrier gas conduit having a discharge end positioned to flow carrier gas into the container.

Clause 18. The product as set forth in clause 17 further comprising a vacuum conduit connected to the electrolyte hopper.

Clause 19. The product as set forth in clause 18 further comprising a filling port connected to the electrolyte hopper for filling liquid solvent into the electrolyte hopper.

Clause 20. The product as set forth in clause 18 further comprising a vacuum pump connected to the vacuum conduit.

While at least illustrative variation has been presented in the foregoing detailed description, it should be appreciated that a vast number of variations exist. It should also be appreciated that a variation or variations are only examples, and are not intended to limit the scope, applicability, or configuration of the disclosure in any way. Rather, the foregoing detailed description will provide those skilled in the art with a convenient road map for implementing the variation or variations. It should be understood that various changes can be made in the function and arrangement of elements without departing from the scope of the disclosure as set forth in the appended claims and the legal equivalents thereof.

What is claimed is:

1. A method comprising:
flowing a solvent vapor over a plurality of interior surfaces of a battery cell, wherein at least one of the plurality of interior surfaces of the battery cell has a plurality of pores formed therein, each pore of the plurality of pores being defined by a pore surface;
condensing the solvent vapor to a liquid solvent so that the liquid solvent is deposited at least on the pore surface of each pore of the plurality of pores; and
thereafter, filling the battery cell with an electrolyte including a solvent and a salt.

2. The method as set forth in claim 1 wherein the liquid solvent is deposited on the at least one of the plurality of interior surfaces.

3. The method as set forth in claim 1 further comprising flowing a carrier gas along with the solvent vapor over the plurality of interior surfaces of the battery cell.

4. The method as set forth in claim 1 further comprising drawing a vacuum on the battery cell to remove gas from the battery cell prior to flowing the solvent vapor over the plurality of interior surfaces of the battery cell.

5. The method as set in claim 1 wherein the solvent vapor has a vapor pressure and a vapor temperature, and wherein condensing the solvent vapor to the liquid solvent comprising adjusting at least one of the vapor pressure or the vapor temperature.

6. The method as set forth in claim 1 wherein the solvent vapor has a vapor pressure and further comprising adjusting the vapor pressure to promote capillary condensation.

7. The method as set forth in claim 1 further comprising heating the solvent vapor flowing over the plurality of interior surfaces of the battery cell.

8. The method as set forth in claim 1 further comprising heating a solvent to produce the solvent vapor.

9. The method as set forth in claim 8 wherein heating the solvent to produce the solvent vapor is performed in a bubbler.

10. The method as set forth in claim 9 further comprising flowing a carrier gas into the bubbler and flowing the carrier gas and the solvent vapor over the plurality of interior surfaces of the battery cell.

11. The method as set forth in claim 1 wherein the plurality of interior surfaces of the battery cell comprising at least one interior surface of a housing enclosing the battery cell, a first electrode, a second electrode, and a separator between the first electrode and the second electrode.

12. The method as set forth in claim 1 further comprising a housing enclosing the battery cell; wherein the plurality of interior surfaces of the battery cell comprising at least one interior surface of a housing enclosing the battery cell, a first electrode, a second electrode, and a separator between the first electrode and the second electrode; heating a solvent to produce the solvent vapor; and flowing a carrier gas into a bubbler and flowing the carrier gas and the solvent vapor over the plurality of interior surfaces of the battery cell.

13. A method comprising:
wetting, with a liquid solvent, a plurality of pore surfaces formed in a substrate of a lithium-ion battery; and
thereafter, filling the lithium-ion battery with a liquid electrolyte.

14. The method as set forth in claim 13 wherein the wetting comprises flowing a solvent vapor over the plurality of pores surfaces formed in the substrate, and thereafter condensing the solvent vapor to the liquid solvent.

15. The method as set forth in claim 14 wherein the substrate comprises at least one of an anode, an active material on the anode, a first face of a separator, a second face of the separator, a cathode, an active material on the cathode, or a surface of a battery housing.

16. A product comprising:
a bubbler including a container and a heat source, a solvent vapor conduit connected to the container and to an electrolyte hopper, the electrolyte hopper having an open end for filling a lithium-ion battery.

17. The product as set forth in claim 16 further comprising a carrier gas conduit connected to the container, the carrier gas conduit having a discharge end positioned to flow carrier gas into the container.

18. The product as set forth in claim 17 further comprising a vacuum conduit connected to the electrolyte hopper.

19. The product as set forth in claim 18 further comprising a filling port connected to the electrolyte hopper for filling liquid solvent into the electrolyte hopper.

20. The product as set forth in claim 18 further comprising a vacuum pump connected to the vacuum conduit.
